(19) United States
(12) Patent Application Publication
(10) Pub. No.: US 2016/0381673 A1
(43) Pub. Date: Dec. 29, 2016

(54) MEMORY MANAGEMENT FOR RECEPTION OF WIRELESS COMMUNICATIONS

(71) Applicant: QUALCOMM Incorporated, San Diego, CA (US)

(72) Inventors: Jing Sun, San Diego, CA (US); Tao Luo, San Diego, CA (US); Taesang Yoo, Riverside, CA (US); Peter Gaal, San Diego, CA (US); Yongbin Wei, La Jolla, CA (US); Durga Prasad Malladi, San Diego, CA (US); Siddhartha Mallik, San Diego, CA (US)

(21) Appl. No.: 15/182,065

(22) Filed: Jun. 14, 2016

Related U.S. Application Data
(60) Provisional application No. 62/184,812, filed on Jun. 25, 2015.

(51) Int. Cl. H04W 72/04; H04L 1/18; G06F 3/06

(52) U.S. Cl. CPC H04W 72/048; G06F 3/0613; G06F 3/065; G06F 3/067; H04W 72/0446; H04L 1/1861

(57) ABSTRACT

A base station or user equipment (UE) may manage scheduling of code blocks to be transmitted and manage memory interface usage to enhance memory read and write operations and provide for enhanced efficiency for decoding of retransmissions of code blocks. In some aspects, a base station or UE may identify an available throughput, or budget, for performing read and write operations to a memory. The base station or UE may then estimate an amount of read and write operations to be performed during a particular time period. In the event that the amount of read and write operations exceed the budget, scheduling of code blocks to be transmitted may be adjusted, one or more read or write operations may be skipped, or combinations thereof may be employed to achieve the memory read and write budget.

### CROSS REFERENCES

The present application for patent claims priority to U.S. Provisional Patent Application No. 62/184,812 by Sun et al., entitled “Memory Management for Reception of Wireless Communications,” filed Jun. 25, 2015 and assigned to the assignee hereof.

### BACKGROUND

Field of the Disclosure

The following relates generally to wireless communication, and more specifically to memory management for reception of wireless communications.

Description of Related Art

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

In many deployments, UEs and base stations may rely on retransmissions of data, or code blocks, in order to successfully receive and decode the transmitted data. In some cases, information from an initial transmission may be stored in a memory and used in conjunction with one or more retransmissions through techniques such as soft combining to decode the transmitted data. In order to perform such decoding techniques for retransmitted data, a UE or base station may store the initial transmission information in memory, which may then be read from memory upon retransmission of the data to be combined with the newly received data. In some cases, a relatively large number of memory reads and writes may need to be performed, and memory management techniques may be desirable to efficiently utilize the memory when performing such read and write operations.

### SUMMARY

The present disclosure, for example, relates to one or more techniques for memory management for transmissions and retransmissions in a wireless communication system. According to various aspects, a base station or UE may manage scheduling of code blocks to be transmitted and manage memory interface usage to enhance memory read and write operations and provide for enhanced efficiency for decoding of retransmissions of code blocks. In some aspects, a base station or UE may identify an available throughput, or budget, for performing read and write operations to a memory. The base station or UE may then estimate an amount of read and write operations to be performed during a particular time period. In the event that the amount of read and write operations exceed the budget, scheduling of code blocks to be transmitted may be adjusted, one or more read or write operations may be skipped, or combinations thereof may be employed to achieve the memory read and write budget.

In some examples, reading of a first portion of data associated with identified code blocks may be skipped, and a second portion of data associated with the identified code blocks may be read. The second portion of data may be, for example, a plurality of systematic bits (e.g., the data bits that are to be transmitted) and the first portion of data may be other bits (e.g., a plurality of bits that may help a UE or base station to decode the systematic bits, such as a plurality of parity bits). The plurality of systematic bits and the plurality of other bits may sometimes be used to generate a plurality of redundant versions of the data to be transmitted (e.g., HARQ redundancy versions (RVs) of the data, which may be identified using a RV identification (RVID)). In some examples, if it is determined that the number of memory reads and writes exceeds the budget, code blocks with different RVIDs, which require less or no memory reads, may be scheduled for transmission.

A method of wireless communication at a wireless device is described. The method may include identifying an available throughput for performing read and write operations to a memory, the read and write operations associated with wireless transmissions received during an identified time period, identifying an amount of data to be read from the memory during the identified time period, and determining whether a write operation is to be skipped based at least in part on the available throughput and the identified amount of data to be read from the memory during the identified time period.

An apparatus for wireless communication at a wireless device is described. The apparatus may include means for identifying an available throughput for performing read and write operations to a memory, the read and write operations associated with wireless transmissions received during an identified time period, means for identifying an amount of data to be read from the memory during the identified time period, and means for determining whether a write operation is to be skipped based at least in part on the available throughput and the identified amount of data to be read from the memory during the identified time period.

A further apparatus for wireless communication at a wireless device is described. The apparatus may include a processor, memory in electronic communication with the processor, and instructions stored in the memory, wherein the instructions are executable by the processor to identify an available throughput for performing read and write operations to a memory, the read and write operations associated with wireless transmissions received during an identified time period, identify an amount of data to be read from the memory during the identified time period, and determine whether a write operation is to be skipped based at least in part on the available throughput and the identified amount of data to be read from the memory during the identified time period.

A non-transitory computer-readable medium storing code for wireless communication at a wireless device is described. The code may include instructions executable to identify an available throughput for performing read and write operations to a memory, the read and write operations associated with wireless transmissions received during an identified time period, identify an amount of data to be read from the memory during the identified time period, and determine whether a write operation is to be skipped based at least in part on the available throughput and the identified amount of data to be read from the memory during the identified time period.

In some examples of the method, apparatuses, or non-transitory computer-readable medium described above, the identified time period corresponds to an orthogonal frequency division multiplexing (OFDM) symbol duration. Additionally or alternatively, in some examples the available throughput for performing read and write operations is based at least in part on a total number of read and write operations that may be performed during the identified time period.

In some examples of the method, apparatuses, or non-transitory computer-readable medium described above, the determining whether a write operation is to be skipped is further based at least in part on a difference between the total number of read and write operations that may be performed during the identified time period and a number of read operations associated with the data to be read from the memory during the identified time period. Additionally or alternatively, some examples may include determining that a write operation is to be performed based at least in part on an unsuccessful attempt to decode data transmitted during the identified time period.

In some examples of the method, apparatuses, or non-transitory computer-readable medium described above, the write operation is determined to be skipped when a sum of the number of read operations associated with the data to be read from the memory during the identified time period and a number of any prior write operations during the identified time period meet or exceed the total number of read and write operations. Additionally or alternatively, in some examples the identifying the amount of data to be read from the memory during the identified time period comprises identifying a plurality of code blocks to be received during the identified time period, and identifying a number of the code blocks that have associated data stored in the memory.

In some examples of the method, apparatuses, or non-transitory computer-readable medium described above, the plurality of code blocks are to be received from two or more pieces of user equipment. Additionally or alternatively, in some examples the identifying the number of the code blocks that have associated data stored in the memory is based at least in part on an RVID associated with one or more code blocks of the plurality of code blocks.

Some examples of the method, apparatuses, or non-transitory computer-readable medium described above may further include determining that the amount of data to be read from the memory during the identified time period exceeds a threshold, and determining to read a first portion of data associated with a subset of the plurality of code blocks and to skip reading data other than the first portion of data associated with a subset of the plurality of code blocks. Additionally or alternatively, in some examples the first portion of data associated with a subset of the plurality of code blocks comprises systematic data.

Some examples of the method, apparatuses, or non-transitory computer-readable medium described above may further include determining that the amount of data to be read from the memory during the identified time period exceeds a threshold, determining to skip reading data stored in the memory for a subset of the plurality of code blocks, and adjusting a redundancy version in an uplink grant to a UE for transmission of the subset of code blocks. Additionally or alternatively, in some examples the read and write operations are associated with a plurality of hybrid automatic repeat request (HARQ) processes associated with data to be transmitted during the identified time period, and wherein the method further comprises determining that the amount of data to be read from the memory during the identified time period exceeds a threshold, determining an amount of data to be read from the memory associated with one or more of the plurality of HARQ processes, and selecting a first HARQ process of the one or more HARQ processes to be deferred to a different time period than the identified time period.

Some examples of the method, apparatuses, or non-transitory computer-readable medium described above may further include selecting a second HARQ process to replace the first HARQ process in an uplink grant. Additionally or alternatively, in some examples the second HARQ process is selected based at least in part on an amount of data to be read from the memory associated with the second HARQ process being less than the amount of data to be read from the memory associated with the first HARQ process.

In some examples of the method, apparatuses, or non-transitory computer-readable medium described above, the plurality of code blocks are to be received in downlink transmissions from a base station. Additionally or alternatively, in some examples an identification of the plurality code blocks to be received in the downlink transmissions is provided in a downlink grant from the base station.

Some examples of the method, apparatuses, or non-transitory computer-readable medium described above may further include determining that the amount of data to be read from the memory during the identified time period exceeds a threshold, and reading at least a portion of the data to be read from the memory before the identified time period. Additionally or alternatively, some examples may include determining that the amount of data to be read from the memory during the identified time period exceeds a threshold, and determining to skip reading data associated with a subset of the plurality of code blocks.

Some examples of the method, apparatuses, or non-transitory computer-readable medium described above may further include determining that the amount of data to be read from the memory during the identified time period exceeds a threshold, and determining to read a first portion of data associated with a subset of the plurality of code blocks and to skip reading data other than the first portion of data associated with a subset of the plurality of code blocks. Additionally or alternatively, in some examples the first portion of data associated with the subset of the plurality of code blocks comprises systematic data.

Some examples of the method, apparatuses, or non-transitory computer-readable medium described above may further include skipping a write operation associated with at least a first code block based at least in part on the available throughput and the amount of data to be read from the memory during the identified time period, and transmitting an indication to the base station associated with at least the first code block for use by the base station in adjusting an RVID for a retransmission of at least the first code block.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

Aspects of the disclosure are described in reference to the following figures:

FIG. 1 illustrates an example of a wireless communications system that supports memory management for reception of wireless communications in accordance with various aspects of the present disclosure;

FIG. 2 illustrates an example of a wireless communications subsystem that supports memory management for reception of wireless communications in accordance with various aspects of the present disclosure;

FIG. 3 illustrates an example of an index of code blocks for transmission during a transmission time interval for wireless communications in accordance with various aspects of the present disclosure;

FIG. 4 shows a block diagram of a wireless communications management module and a memory module that support memory management for reception of wireless communications in accordance with various aspects of the present disclosure;

FIG. 5 illustrates an example of a process flow that supports memory management for reception of wireless communications in accordance with various aspects of the present disclosure;

FIG. 6 illustrates an example of memory read profiles before and after memory management for reception of wireless communications in accordance with various aspects of the present disclosure;

FIG. 7 illustrates an example of a process flow that supports memory management for reception of wireless communications in accordance with various aspects of the present disclosure;

FIGS. 8-10 show block diagrams of a wireless device that supports memory management for reception of wireless communications in accordance with various aspects of the present disclosure;

FIG. 11 illustrates a block diagram of a system including a device that supports memory management for reception of wireless communications in accordance with various aspects of the present disclosure;

FIG. 12 illustrates a block diagram of a system including a base station that supports memory management for reception of wireless communications in accordance with various aspects of the present disclosure; and

FIGS. 13-16 illustrate methods for memory management for reception of wireless communications in accordance with various aspects of the present disclosure.

### DETAILED DESCRIPTION

Techniques for memory management for transmissions and retransmissions in a wireless communication system are described. As mentioned above, a wireless communications device, such as a UE or base station, may rely on retransmissions of data, such as code blocks, to successfully decode data in the transmissions. Such retransmissions may result in memory reads and writes to be performed in conjunction with the retransmission techniques (e.g., log likelihood ratios (LLRs) may be read and written per OFDM symbol). In some systems, a worst case may be determined for memory throughput that is associated with data throughput, HARQ state, and code rate for a given time period (e.g., a duration of an OFDM symbol). This worst case throughput may then be used to design a memory interface and select memory to be used in a design, which is then capable of performing sufficient read and write operations to support the worst-case scenario in the design. However, as data rates increase, such techniques may result in relatively expensive memory interfaces and memory. Various aspects of the present disclosure provide for management of memory read and write operations as part of the design process, that may be used to manage the amount of data read from or written to memory, which may allow for enhanced efficiency in use of the memory and interface, and result in a lower cost and complexity design.

According to some aspects of the disclosure, for a given memory (e.g., a double data rate synchronous dynamic random-access memory (DDR SDRAM)) throughput a base station or UE may control the scheduling and memory interface usage. For example, a base station may include a scheduler that makes scheduling decisions for uplink (UL) transmissions from a UE. The scheduler may, for example, determine which UEs to schedule, which rank/modulation and coding scheme (MCS) to implement, over which resource to communicate, and which RVID to use. Aspects of the present disclosure provide techniques for a base station to adjust RVID to help manage memory read/write load. Further, aspects of the present disclosure provide techniques for a base station or UE to determine whether to skip one or more memory read or write operations for one or more code blocks (CBs). In some examples, a UE or base station may read certain information associated with CBs, such as reading of systematic bits LLR information, and skipping non-systematic bits. Additionally, in some examples, read operations may be prioritized over write operations, with one or more write operations being skipped (or writing of non-systematic bits skipped) before skipping read operations. For CBs in retransmission, a base station or UE may monitor what RVIDs are already received and an associated range of LLRs already in memory buffer, which may be used to determine a number of memory reads that are to be performed for a particular scheduling of uplink or downlink transmissions.

Aspects of the disclosure are initially described in the context of a wireless communication system. Specific examples are then described for memory reads and writes for identified time intervals. These and other aspects of the disclosure are further illustrated by and described with reference to apparatus diagrams, system diagrams, and flowcharts that relate to memory management for reception of wireless communications.

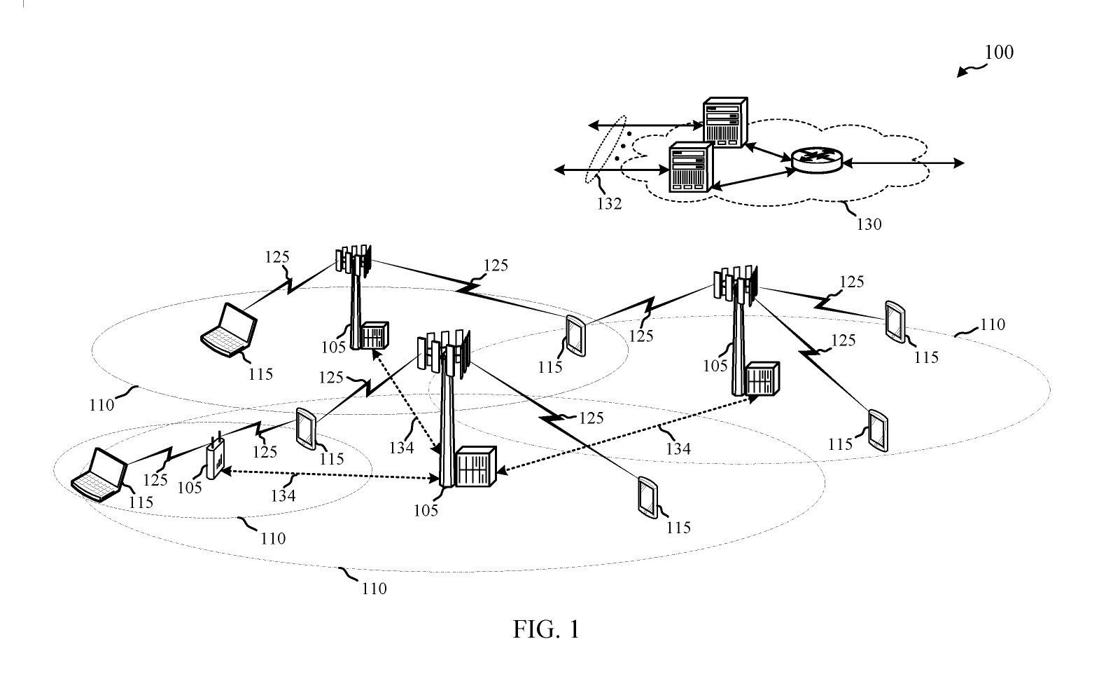

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be an LTE/LTE-advanced (LTE-A) network.

Base stations 105 may wirelessly communicate with UEs 115 via one or more base station antennas. Each base station 105 may provide communication coverage for a respective geographic coverage area 110. Communication links 125 shown in wireless communications system 100 may include UL transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal, a handset, a user agent, a client, or some other suitable terminology. A UE 115 may also be a cellular phone, a wireless modem, a handheld device, a personal computer, a tablet, a personal electronic device, a machine type communication (MTC) device or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

As mentioned above, UEs 115 or base stations 105 may rely on retransmissions of data, such as CBs, to successfully decode data in the transmissions. Such retransmissions may result in memory reads and writes to be performed in conjunction with the retransmission techniques (e.g., LLRs) may be read and written per OFDM symbol). HARQ is one such retransmission technique for ensuring that data is received correctly over a wireless communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., signal-to-noise conditions). In Incremental Redundancy HARQ, incorrectly received data may be stored in a buffer and combined with subsequent transmissions to improve the overall likelihood of successfully decoding the data. In some cases, redundancy bits are added to each message prior to transmission, which may be identified by a RVID. This may be especially useful in poor conditions. In other cases, redundancy bits are not added to each transmission, but are retransmitted after the transmitter of the original message receives a negative acknowledgement (NACK) indicating a failed attempt to decode the information. The chain of transmission, response and retransmission may be referred to as a HARQ process. In some cases, a limited number of HARQ processes may be used for a given communication link 125.

In some cases, wireless communications system 100 may utilize one or more enhanced component carriers (eCCs). An eCC may be characterized by one or more features including: wider bandwidth, shorter symbol duration, shorter transmission time interval (TTIs), and modified control channel configuration. In some cases, an eCC may be associated with a carrier aggregation (CA) configuration or a dual connectivity configuration (e.g., when multiple serving cells have a suboptimal or non-ideal backhaul link backhaul link). An eCC may also be configured for use in unlicensed spectrum or shared spectrum (e.g., where more than one operator is allowed to use the spectrum). An eCC characterized by wide bandwidth may include one or more segments that may be utilized by UEs 115 that do are not capable of monitoring the whole bandwidth or prefer to use a limited bandwidth (e.g., to conserve power).

In some cases, an eCC may utilize a different symbol duration than other component carriers (CCs), which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 MHz, etc.) at reduced symbol durations (e.g., 16.67 μs). A TTI in eCC may consists of one or multiple symbols. In some cases, the TTI duration (that is, the number of symbols in a TTI) may be variable.

Various aspects of the present disclosure provide for management of memory read and write operations, such as HARQ-related read and write operations, as part of the design process, that may be used to manage the amount of data read from or written to memory. Such techniques may allow for enhanced efficiency in use of the memory and interface, and result in a lower cost and complexity design. According to some aspects of the disclosure, for a given memory (e.g., a DDR memory) throughput a base station 105 or UE 115 may control the scheduling and memory interface usage. For example, a base station 105 may include a scheduler that makes scheduling decisions for UL transmissions from a UE 115. The scheduler may, for example, adjust RVIDs to help manage memory read/write load. Further, aspects of the present disclosure provide techniques for a base station 105 or UE 115 to determine whether to skip one or more memory read or write operations for one or more CBs. In some examples, a UE 115 or base station 105 may read certain information associated with CBs, such as reading of systematic bits LLR information, and skipping non-systematic bits. Additionally, in some examples, read operations may be prioritized over write operations, with one or more write operations being skipped (or writing of non-systematic bits skipped) before skipping read operations. For CBs in retransmission, a base station 105 or UE 115 may monitor what RVIDs are already received and an associated range of LLRs already in memory buffer, which may be used to determine a number of memory reads that are to be performed for a particular scheduling of uplink or downlink transmissions.

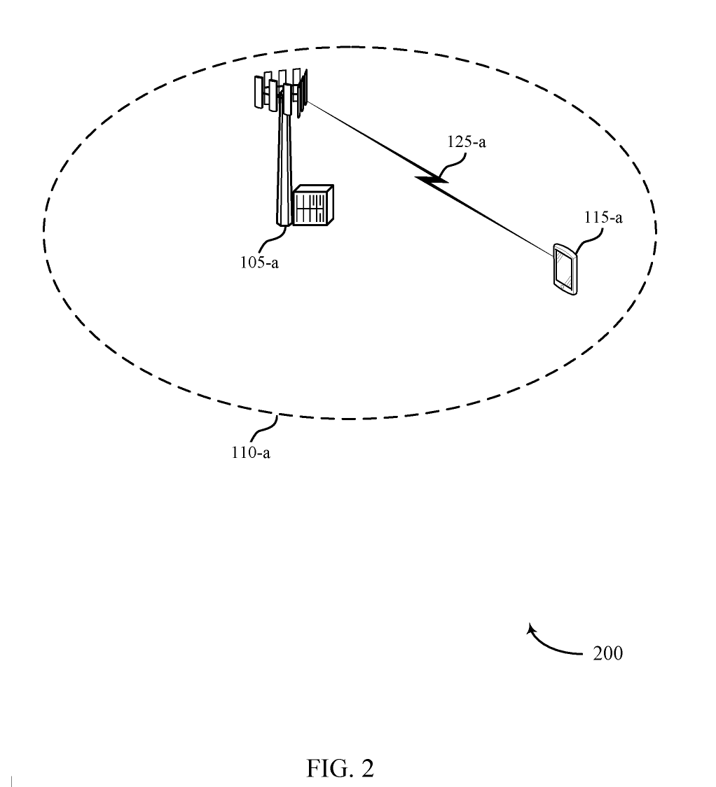

FIG. 2 illustrates an example of a wireless communications subsystem 200 for memory management for reception of wireless communications in accordance with various aspects of the present disclosure. Wireless communications subsystem 200 may include a device 115-a and base station 105-a, which may be examples of a UE 115 base station 105 described with reference to FIG. 1. Base station 105-a may have a coverage area 110-a, and communicate with device 115-a via communications link 125-a.

As discussed above, base station 105-a may schedule uplink transmissions, and thus has knowledge, for each scheduled OFDM symbol, of which CBs are to be transmitted from UE 115-a. While only one UE 115-a is illustrated in FIG. 2, many UEs 115 may be in communication with base station 105-a. In addition to the CBs to be transmitted during scheduled OFDM symbols, the base station 115-a also has knowledge, for each CB, whether data associated with the CB is in memory. For example, base station 115-a may keep an LLR buffer, and may determine, based on the LLR buffer, whether any of the scheduled CBs have an RVID in the LLR buffer. If no RVID associated with a CB is in the buffer, the base station 115-a will not need to perform a memory read operation associates with the CB, although a write operation may need to be performed if the base station 105-a is unable to receive and decode the transmission. Thus, for each OFDM symbol, the base station 105-a may determine the amount of data to be read from the memory.

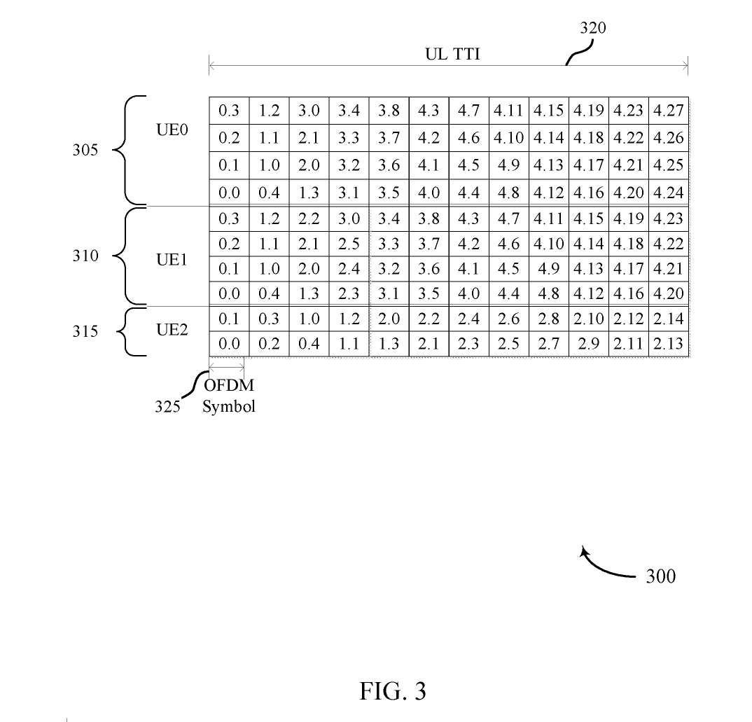

FIG. 3 is an example 300 of an index of CBs that may be scheduled for three UEs 115, and may include a UE0 portion 305, a UE1 portion 310, and a UE2 portion 310. The index 300 may cover a TTI 320, which may include a number of OFDM symbols 325. Each scheduled CB may include a transport block identification as the first number to the left of the decimal point, and a code block identification as the second to the right of the decimal point. Thus, during a first OFDM symbol 325, UE0 may be scheduled to transmit CBs 0 through 3 of transport block 0. The base station (e.g., base station 105 of FIGS. 1-2) may determine if any RVID associated with CNs 0 through 3 of transport block 0 are in the buffer, and thus determine if a read operation is to be performed for any of the CBs.

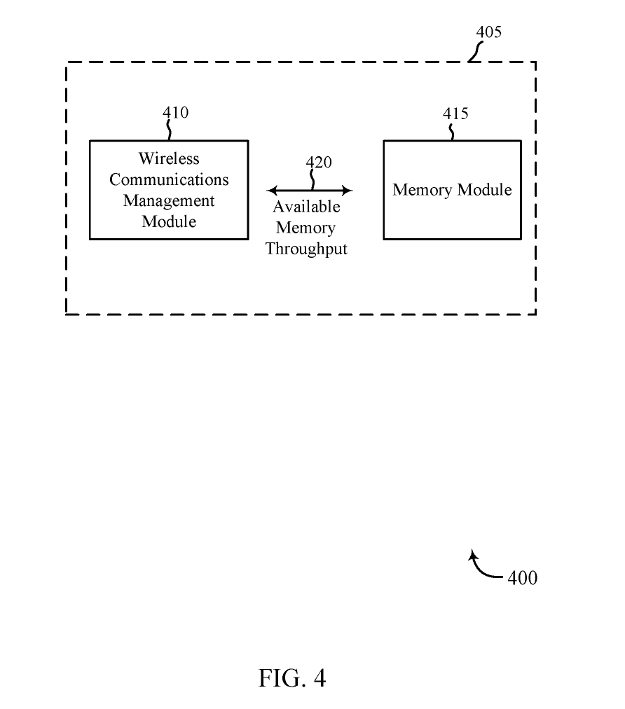

FIG. 4 is an example 400 of a portion of a wireless device 405, such as a base station 105 or UE 115 of FIGS. 1-2. The device 405 may include a wireless communications management module 410, and a memory module 415. As mentioned above, the memory interface of the wireless communications management module 410, and the memory module 415 may be selected to provide an available memory throughput 420, which may also be referred to as a memory access budget (e.g., 50k read+write in one OFDM symbol). For examples where wireless device 405 is a base station, the wireless communications management module 410 can check if the UL transmissions for an OFDM symbol (e.g., through checking of RVIDs associated with CBs to be transmitted) will generate memory read operations that fit within the budget. If the memory reads for the OFDM symbol will not fit within the budget, the wireless communications management module 410 choose to not perform memory read operations for some CBs in order to make the reads fit the budget. According to some examples, where the wireless communications management module 410 is included in a base station, one or more RVIDs in the UL grant scheduling can be adjusted at the same time in order to reduce the amount of data to be read for an OFDM symbol. For example, if the wireless communications management module 410 plans to skip a read operation for a CB, the wireless communications management module 410 may request RVID 0 for that CB. Furthermore, in some examples, memory write operations may be skipped if such write operations exceed the available memory throughput 420. Thus, in effect, such write operations can be performed on a best efforts basis to consume any remaining available memory throughput 420. Memory write operations may be more difficult to predict, because it is not known prior to transmission of the OFDM symbol whether a write operation will be necessary. In some examples, write operations may be allocated a certain amount of budget in order to ensure that at least some memory write operations may be performed for an OFDM symbol. In some examples, memory read operations may be favored over memory write operations, as it is more wasteful to skip a read as memory resources have already been expended to write the data previously.

In further examples, where wireless device 405 is a base station, the wireless communications management module 410 may further use another degree of freedom in the HARQ process domain. In such examples, if the read and write operations for a time period are approaching the available memory throughput 420, the wireless communications management module 410 may initiate a new HARQ process (if available), which results in no memory read operation for the new transport block associated with the new HARQ operation. Furthermore, if there are multiple HARQ processes to choose from, they may have different RVID requirements which may impact the amount of information that needs to be read from the memory module 415. In some examples, the wireless communications management module 410 may pick HARQ processes that fits the budget or result in less skipping of read operations.

In examples, where the wireless device 405 is a UE (e.g., UE 115 of FIGS. 1-2), the wireless communications management module 410 may similarly perform various management techniques to enhance efficiency of read and write operations to memory module 415. For a UE, within one OFDM symbol, all assigned resource blocks will belong to one physical downlink shared channel (PDSCH) with a single MCS, and all CBs within an OFDM symbol will have a same RVID (except the boundary of TBs within a TTI under CB level retransmission). Upon reception of the DL grant in PDCCH, the UE may identify, in each OFDM symbol, what CBs will require a memory read operation, and this information may be used to determine a memory read profile for each OFDM symbol. In some examples, if on-chip memory allows, one or more memory read operations may be scheduled ahead of time (e.g., prior to the OFDM symbol) in the read operations exceed the available memory throughput 420. If the available memory throughput 420 is still exceeded, the UE may, in some examples, skip one or more read operations, or may skip reading certain portions of information stored in memory module 415 (e.g., non-systematic data may be skipped). Further, as discussed above, memory write operations may be skipped as well, and may be skipped ahead of skipping one or more read operations (e.g., read/write operations associated with useful information may by skipped so as to compensate for memory access interface limitations or desired thresholds). In some examples, if the wireless communications management module 410 skips a write operation, an indication (e.g., an indication of bursty interference) may be provided to the base station that may be used in adjusting a RVID for a retransmission of the first code block associated with the skipped write operation.

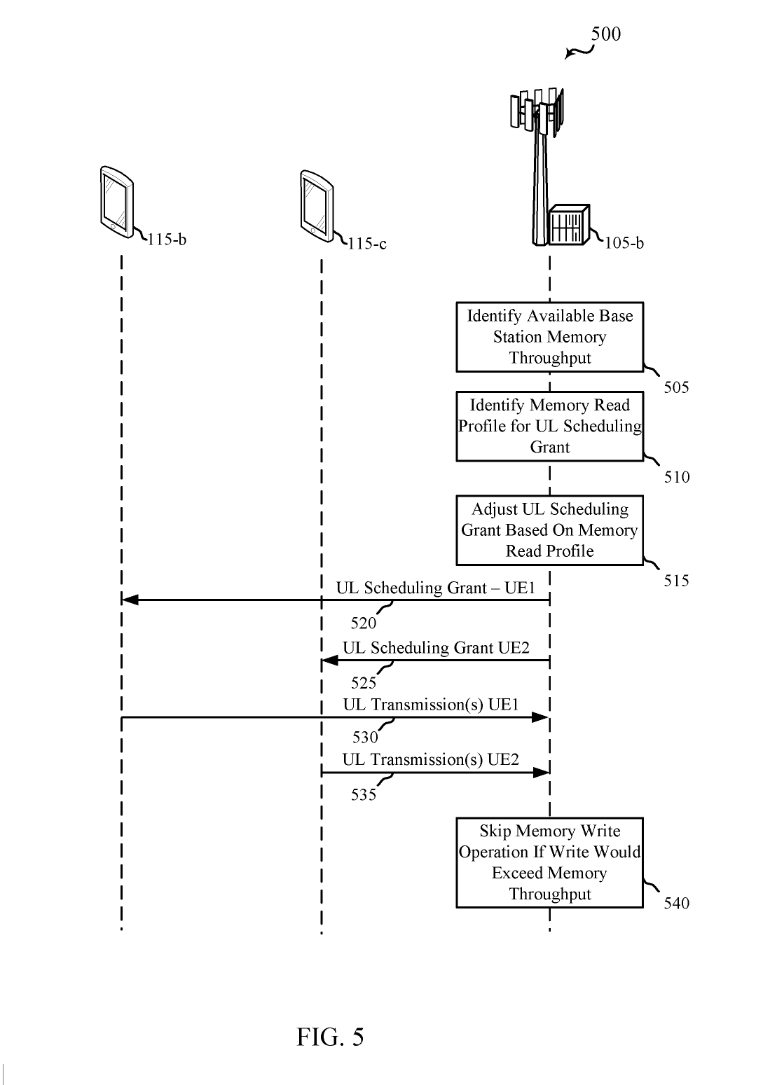

FIG. 5 illustrates an example of a process flow 500 for memory management for reception of wireless communications in accordance with various aspects of the present disclosure. Process flow 500 may include a device 115-b, a device 115-c, and base station 105-b, which may be examples of a UE 115 and base station 105 described with reference to FIGS. 1-2, or of device 405 of FIG. 4. At block 505, the base station 105-b may identify an available base station memory throughput for performing read and write operations to a memory. At block 510, base station 105-b may identify a memory read profile for a UL scheduling grant. At block 515, the base station may adjust the UL scheduling grant based on the memory read profile. For example, as discussed above, the base station 105-b may adjust one or more RVIDs associated with an UL transmission, may initiate a new HARQ operation, may determine to skip one or more read operations (and may adjust an associated RVID accordingly), or combinations thereof. The base station 105-b then transmits UL scheduling grant 520 to UE 115-b, and transmits UL scheduling grant 525 to UE 115-c. UE 115-b may transmit UL transmission(s) 530 to base station 105-b, and UE 115-c may transmit UL transmission(s) 535 to base station 105-b. The base station 540 may, at block 540, skip a memory write operation of the write would exceed memory throughput, similarly as discussed above.

In one example, base station 105-b may, for a new UL scheduling grant (for PUSCH on UL TTI N) that the base station 105-b plans to add, perform the following operations:
1) Determine the existing memory read/write requirement for each symbol in the UL TTI N: x(k), k=symbol index=0, . . . , 11
2) Determine the additional memory read requirement due to the grant: r(k)=Σₘ r(k,m), m=CB index, k=symbol index
   1) For new CB, r(k,m)=0
   2) For retransmitted CB with ARQ, r(k,m)=0
   3) For retransmitted CB with CC, r(k,m)=1* . . . .
   4) For retransmitted CB with IR, r(k,m)=3* . . . .
3) Determine the additional memory write requirement due to the grant, assuming conservatively that the decoding will fail: w(k)=Σₘw(k,m)
   1) For last retransmission, w(k,m)=0
   2) For ARQ, w(k,m)=0
   3) For CC, w(k,m)=1* . . . .
   4) For IR, w(k,m)=3* . . . .
4) Compute the new memory read/write requirement: y(k)=x(k)+r(k)+w(k) for each of ARQ, CC, and IR
5) Choose the mode {ARQ, CC, IR} for the grant such that y(k) does not exceed the memory throughput budget for all symbol indices k=0, . . . , 11.
   This particular example of a base station algorithm is an illustration for TDM scheduling, but it can be easily extended to FDM scheduling scenarios. Furthermore, various modifications may be made to this example in accordance with various of the techniques described herein. It is to be appreciated that, in various examples, a receiver of base station 105-b may have both receiver and scheduler information, and a scheduler of base station 105-b that makes scheduling decisions can be used as a tool to reduce DDR requirements associated with the operations corresponding to this receiver and scheduler information. In this regard, RVIDs (and, in some cases, a HARQ process IDs) may be actively changed during an UL scheduling phase. As such, in accordance with some example of the disclosure, when data associated with an UL transmission is received, the DDR memory driver throughput does not exceed a particular threshold.

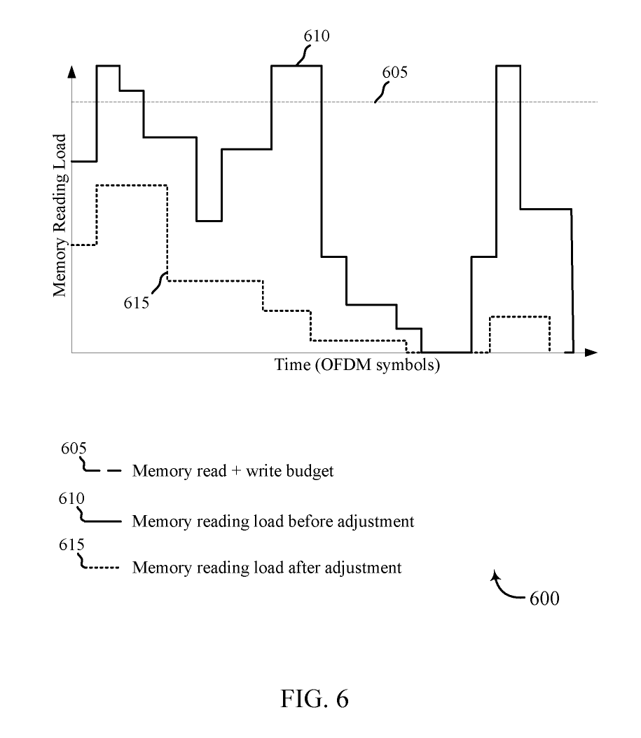

FIG. 6 illustrates an example 600 of memory read profiles before and after memory management for reception of wireless communications in accordance with various aspects of the present disclosure. In this example, the X-axis represents time (measured in OFDM symbols) and Y-axis represents memory reading load. For each time period, a time trace of reading load may be determined, with an initial time trace 610 representing memory read load before adjustment with an originally planned RVID. The memory read and write budget 605 may also be identified, and a comparison of the read and write budget 605 with reading load before adjustment 610 indicates that the read and write budget 605 is exceeded for some OFDM symbol. Based on the determination that the read and write budget 605 is exceeded for some OFDM symbols, one or more of the various management techniques described herein may be implemented, and memory reading profile after adjustment 615 may be determined which, in this example, remains below the read and write budget 605.

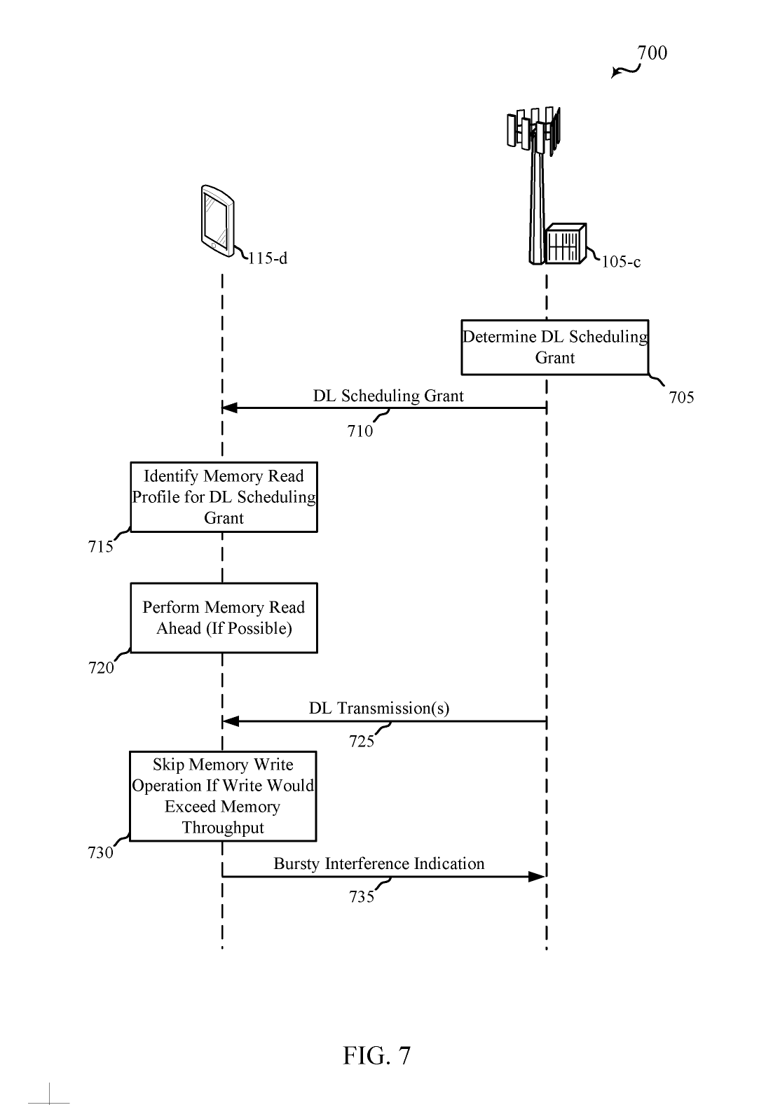

FIG. 7 illustrates an example of a process flow 700 for memory management for reception of wireless communications in accordance with various aspects of the present disclosure. Process flow 700 may include a device 115-d, and base station 105-c, which may be examples of a UE 115 and base station 105 described with reference to FIGS. 1-2, or of device 405 of FIG. 4. At block 705, the base station 105-c may determine a DL scheduling grant. The base station 105-c may transmit the DL scheduling grant 710 to device 115-d. At block 715, device 115-d may identify a memory read profile for the DL scheduling grant. At block 710, the device 115-d may perform memory read-ahead, if possible, to perform one or more memory read operations in advance and keep the memory read provide below an available memory throughput. Base station 105-c may then transmit DL transmission(s) 725. The device 115-d may, at block 730, skip a memory write operation of the write would exceed memory throughput, similarly as discussed above. The device 115-d may transmit a bursty interference indication 735 to assist the base station 105-c in assigning a RVID for subsequent retransmissions.

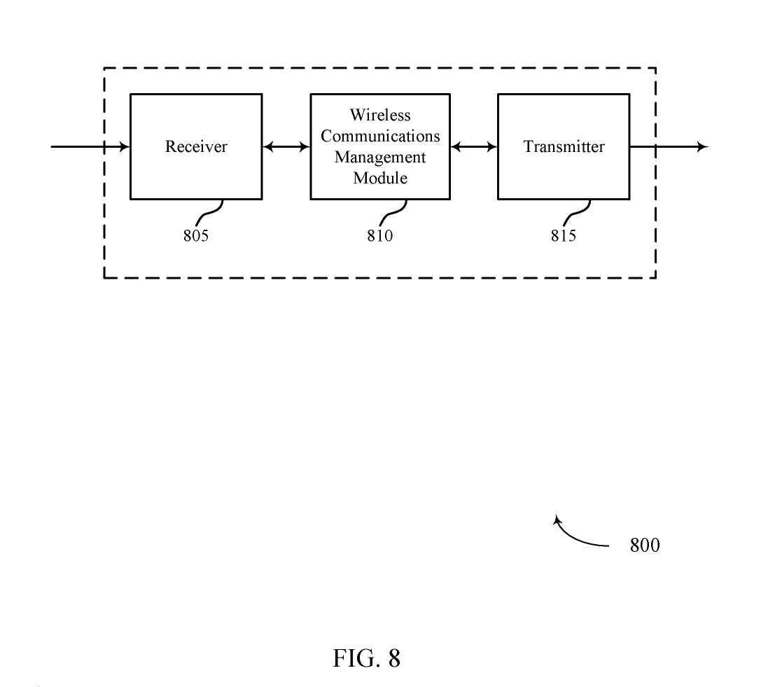

FIG. 8 shows a block diagram of a wireless device 800 configured for memory management for reception of wireless communications in accordance with various aspects of the present disclosure. Wireless device 800 may be an example of aspects of a device 115 described with reference to FIGS. 1-7. Wireless device 800 may include a receiver 805, a wireless communications management module 810, or a transmitter 815. Wireless device 800 may also include a processor. Each of these components may be in communication with each other.

The receiver 805 may receive information such as packets, user data, or control information associated with various information channels (e.g., control channels, data channels, and information related to memory management for reception of wireless communications, etc.). Information may be passed on to the wireless communications management module 810, and to other components of wireless device 800.

The wireless communications management module 810 may identify an available throughput for performing read and write operations to a memory, the read and write operations associated with wireless transmissions received during an identified time period, identify an amount of data to be read from the memory during the identified time period, and determine whether a write operation is to be skipped based at least in part on the available throughput and the identified amount of data to be read from the memory during the identified time period.

The transmitter 815 may transmit signals received from other components of wireless device 800. In some examples, the transmitter 815 may be collocated with the receiver 805 in a transceiver module. The transmitter 815 may include a single antenna, or it may include a plurality of antennas.

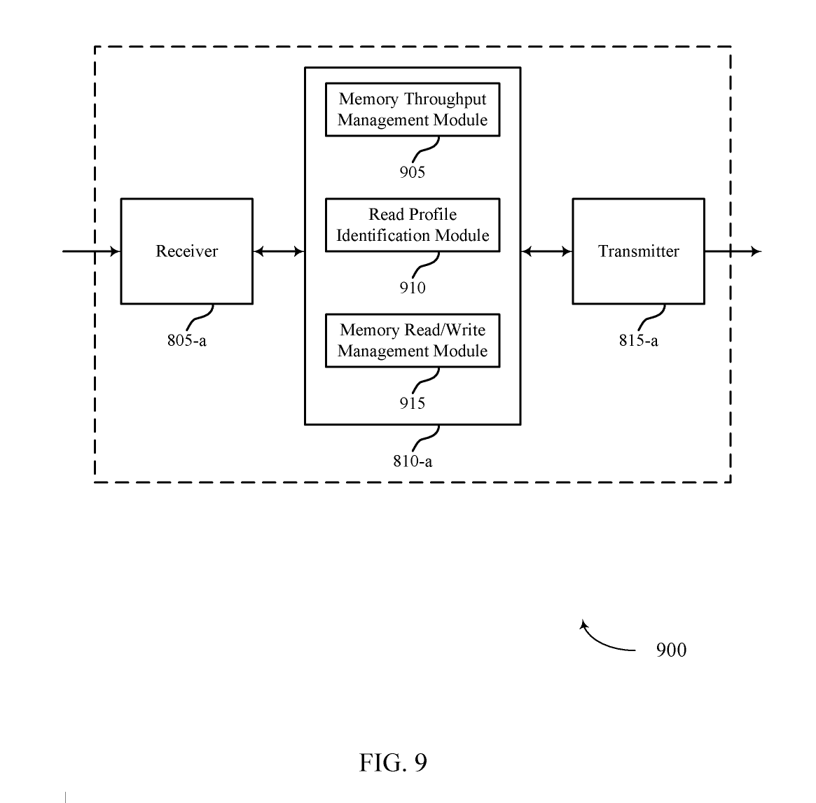

FIG. 9 shows a block diagram of a wireless device 900 for memory management for reception of wireless communications in accordance with various aspects of the present disclosure. Wireless device 900 may be an example of aspects of a wireless device 800 or a device 115 described with reference to FIGS. 1-8. Wireless device 900 may include a receiver 805-a, a wireless communications management module 810-a, or a transmitter 815-a. Wireless device 900 may also include a processor. Each of these components may be in communication with each other. The wireless communications management module 810-a may also include a memory throughput management module 905, a read profile identification module 910, and a memory read/write management module 915.

The receiver 805-a may receive information which may be passed on to wireless communications management module 810-a, and to other components of wireless device 900. The wireless communications management module 810-a may perform the operations described with reference to FIG. 8. The transmitter 815-a may transmit signals received from other components of wireless device 900.

The memory throughput management module 905 may identify an available throughput for performing read and write operations to a memory, the read and write operations associated with wireless transmissions received during an identified time period as described with reference to FIGS. 2-7. In some examples, the identified time period corresponds to an OFDM symbol duration. In some examples, the available throughput for performing read and write operations may be based at least in part on a total number of read and write operations that may be performed during the identified time period. The memory throughput management module 905 may also determine that a write operation is to be performed based at least in part on an unsuccessful attempt to decode data transmitted during the identified time period. In some examples, the plurality of code blocks are to be received in downlink transmissions from a base station. In some examples, an identification of the plurality code blocks to be received in the downlink transmissions may be provided in a downlink grant from the base station.

The read profile identification module 910 may identify an amount of data to be read from the memory during the identified time period as described with reference to FIGS. 2-7. In some examples, the plurality of code blocks are to be received from two or more pieces of user equipment. The read profile identification module 910 may also determine that the amount of data to be read from the memory during the identified time period exceeds a threshold. The read profile identification module 910 may also determine that the amount of data to be read from the memory during the identified time period exceeds a threshold. In some examples, the read and write operations are associated with a plurality of HARQ processes associated with data to be transmitted during the identified time period, and the read profile identification module 910 may also determine that the amount of data to be read from the memory during the identified time period exceeds a threshold. In some examples, the first portion of data associated with the subset of the plurality of code blocks comprises systematic data.

The memory read/write management module 915 may determine whether a write operation is to be skipped based at least in part on the available throughput and the identified amount of data to be read from the memory during the identified time period as described with reference to FIGS. 2-7. In some examples, the determining whether a write operation is to be skipped may be further based at least in part on a difference between the total number of read and write operations that may be performed during the identified time period and a number of read operations associated with the data to be read from the memory during the identified time period. In some examples, the write operation may be determined to be skipped when a sum of the number of read operations associated with the data to be read from the memory during the identified time period and a number of any prior write operations during the identified time period meet or exceed the total number of read and write operations. The memory read/write management module 915 may also determine to read a first portion of data associated with a subset of the plurality of code blocks and to skip reading data other than the first portion of data associated with a subset of the plurality of code blocks. In some examples, the first portion of data associated with a subset of the plurality of code blocks comprises systematic data. The memory read/write management module 915 may also determine to skip reading data stored in the memory for a subset of the plurality of code blocks. The memory read/write management module 915 may also read at least a portion of the data to be read from the memory before the identified time period. The memory read/write management module 915 may also determine to skip reading data associated with a subset of the plurality of code blocks. The memory read/write management module 915 may also determine to read a first portion of data associated with a subset of the plurality of code blocks and to skip reading data other than the first portion of data associated with a subset of the plurality of code blocks. The memory read/write management module 915 may also skip a write operation associated with at least a first code block based at least in part on the available throughput and the amount of data to be read from the memory during the identified time period.

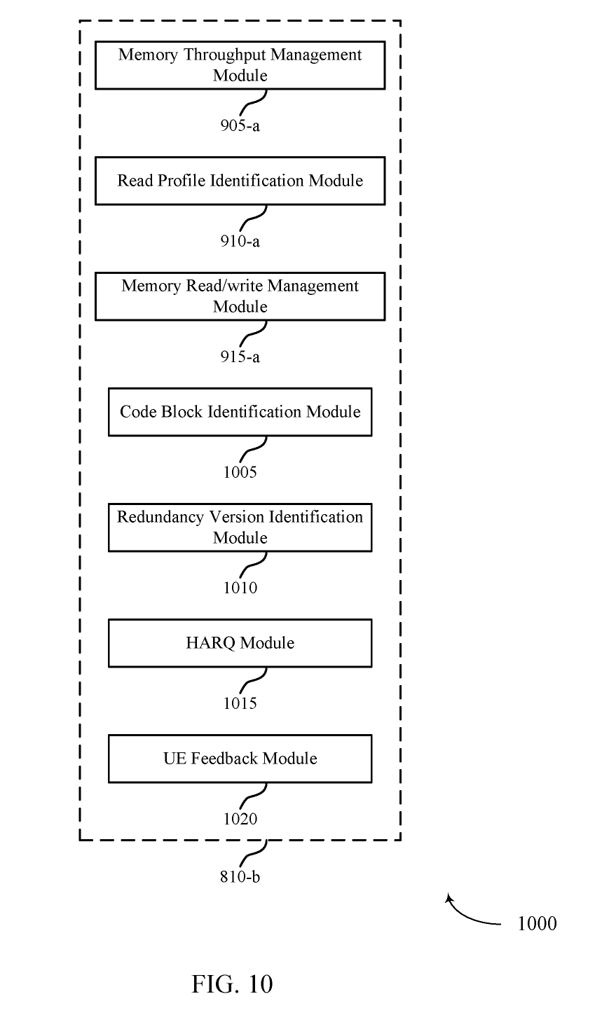

FIG. 10 shows a block diagram 1000 of a wireless communications management module 810-b which may be a component of a wireless device 800 or a wireless device 900 for memory management for reception of wireless communications in accordance with various aspects of the present disclosure. The wireless communications management module 810-b may be an example of aspects of a wireless communications management module 810 described with reference to FIGS. 8-9. The wireless communications management module 810-b may include a memory throughput management module 905-a, a read profile identification module 910-a, and a memory read/write management module 915-a. Each of these modules may perform the functions described with reference to FIG. 9. The wireless communications management module 810-b may also include a code block identification module 1005, a redundancy version identification module 1010, a HARQ module 1015, and a UE feedback module 1020.

The code block identification module 1005 may be configured such that the identifying the amount of data to be read from the memory during the identified time period may include identifying a plurality of code blocks to be received during the identified time period as described with reference to FIGS. 2-7. The code block identification module 1005 may also identify a number of the code blocks that have associated data stored in the memory. In some examples, the identifying the number of the code blocks that have associated data stored in the memory may be based at least in part on an RVID associated with each code block.

The redundancy version identification module 1010 may adjust a redundancy version in an uplink grant to a UE for transmission of the subset of code blocks as described with reference to FIGS. 2-7.

The HARQ module 1015 may determine an amount of data to be read from the memory associated with one or more of the plurality of HARQ processes as described with reference to FIGS. 2-7. The HARQ module 1015 may also select a first HARQ process of the one or more HARQ processes to be deferred to a different time period than the identified time period. The HARQ module 1015 may also select a second HARQ process to replace the first HARQ process in an uplink grant. In some examples, the second HARQ process may be selected based at least in part on an amount of data to be read from the memory associated with the second HARQ process being less than the amount of data to be read from the memory associated with the first HARQ process.

The UE feedback module 1020 may transmit an indication to the base station associated with at least the first code block for use by the base station in adjusting an RVID for a retransmission of at least the first code block as described with reference to FIGS. 2-7.

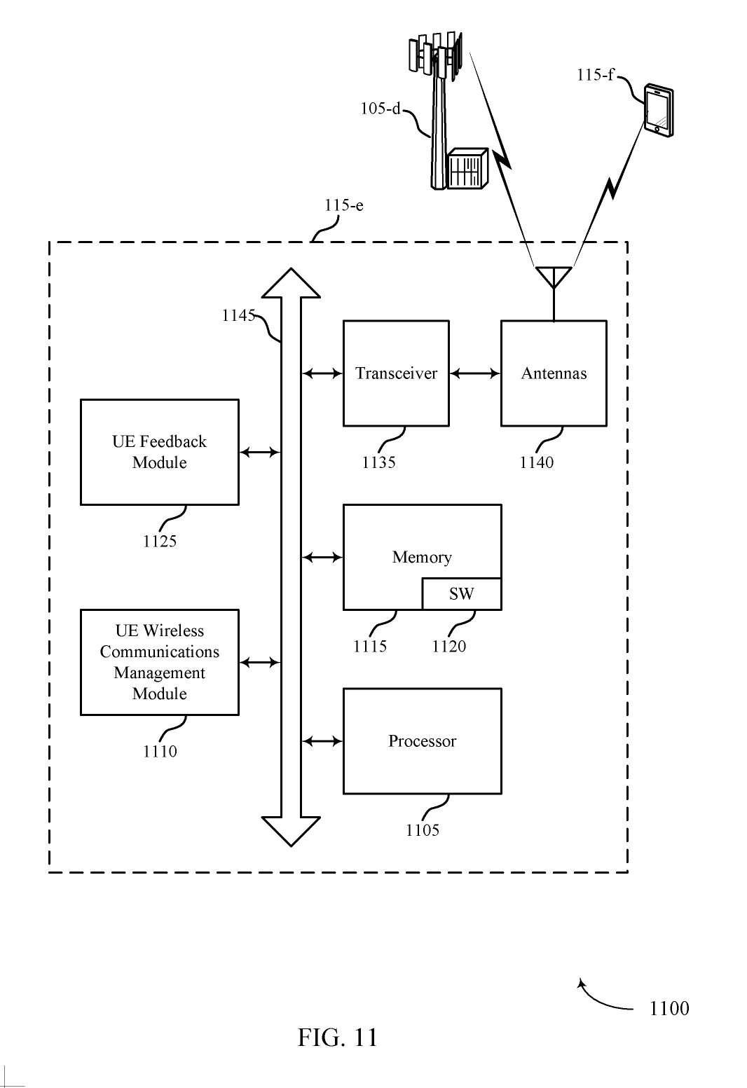

FIG. 11 shows a diagram of a system 1100 including a device 115-e configured for memory management for reception of wireless communications in accordance with various aspects of the present disclosure. System 1100 may include device 115-e, which may be an example of a wireless device 400, a wireless device 800, a wireless device 900, or a device 115 described with reference to FIGS. 1-10. Device 115-e may include a wireless communications management module 1110, which may be an example of a wireless communications management module 410 or 810 described with reference to FIG. 4 or 8-10. device 115-e may also include a UE feedback module 1125 (e.g., that indicates bursty interference indications). Device 115-e may also include components for bi-directional voice and data communications including components for transmitting communications and components for receiving communications. For example, device 115-e may communicate bi-directionally with UE 115-f or base station 105-d.

UE 115-e may also include a processor 1105, and memory 1115 (including software (SW)) 1120, a transceiver 1135, and one or more antenna(s) 1140, each of which may communicate, directly or indirectly, with one another (e.g., via buses 1145). The transceiver 1135 may communicate bi-directionally, via the antenna(s) 1140 or wired or wireless links, with one or more networks, as described above. For example, the transceiver 1135 may communicate bi-directionally with a base station 105 or another UE 115. The transceiver 1135 may include a modem to modulate the packets and provide the modulated packets to the antenna(s) 1140 for transmission, and to demodulate packets received from the antenna(s) 1140. While UE 115-e may include a single antenna 1140, UE 115-e may also have multiple antennas 1140 capable of concurrently transmitting or receiving multiple wireless transmissions.

The memory 1115 may include random access memory (RAM) and read only memory (ROM). The memory 1115 may store computer-readable, computer-executable software/firmware code 1120 including instructions that, when executed, cause the processor 1105 to perform various functions described herein (e.g., memory management for reception of wireless communications, etc.). Alternatively, the software/firmware code 1120 may not be directly executable by the processor 1105 but cause a computer (e.g., when compiled and executed) to perform functions described herein. The processor 1105 may include an intelligent hardware device, (e.g., a central processing unit (CPU), a microcontroller, an application specific integrated circuit (ASIC), etc.)

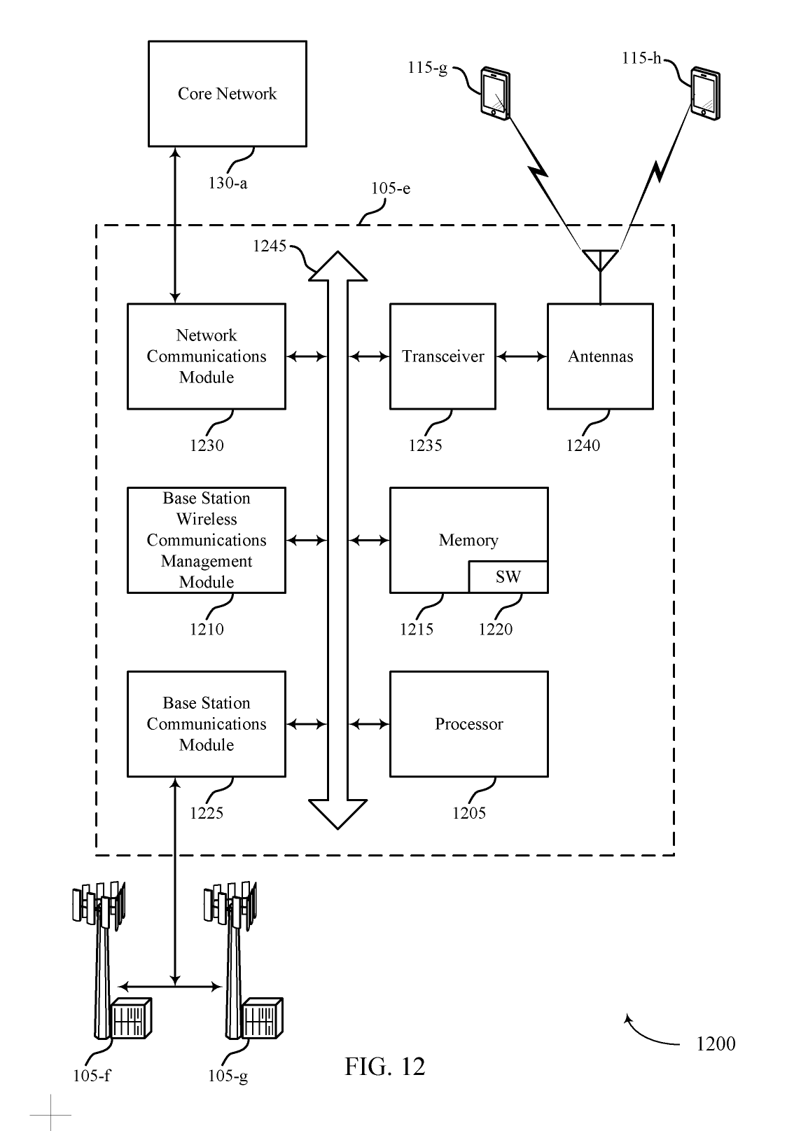

FIG. 12 shows a diagram of a system 1200 including a base station 105 configured for memory management for reception of wireless communications in accordance with various aspects of the present disclosure. System 1200 may include base station 105-e, which may be an example of a wireless device 900, a wireless device 1000, or a base station 105 described with reference to FIGS. 1, 2 and 9-11. Base Station 105-e may include a base station wireless communications management module 1210, which may be an example of a wireless communications management module 410, 1210 described with reference to FIG. 4 or 9-11. Base Station 105-e may also include components for bi-directional voice and data communications including components for transmitting communications and components for receiving communications. For example, base station 105-e may communicate bi-directionally with UE 115-g or UE 115-g.

In some cases, base station 105-e may have one or more wired backhaul links. Base station 105-e may have a wired backhaul link (e.g., S1 interface, etc.) to the core network 130. Base station 105-e may also communicate with other base stations 105, such as base station 105-f and base station 105-g via inter-base station backhaul links (e.g., an X2 interface). Each of the base stations 105 may communicate with UEs 115 using the same or different wireless communications technologies. In some cases, base station 105-e may communicate with other base stations such as 105-f or 105-g utilizing base station communication module 1225. In some examples, base station communication module 1225 may provide an X2 interface within an LTE/LTE-A wireless communication network technology to provide communication between some of the base stations 105. In some examples, base station 105-e may communicate with other base stations through core network 130. In some cases, base station 105-e may communicate with the core network 130 through network communications module 1230.

The base station 105-e may include a processor 1205, memory 1215 (including SW1220), transceiver 1235, and antenna(s) 1240, which each may be in communication, directly or indirectly, with one another (e.g., over bus system 1245). The transceivers 1235 may be configured to communicate bi-directionally, via the antenna(s) 1240, with the UEs 115, which may be multi-mode devices. The transceiver 1235 (or other components of the base station 105-e) may also be configured to communicate bi-directionally, via the antennas 1240, with one or more other base stations (not shown). The transceiver 1235 may include a modem configured to modulate the packets and provide the modulated packets to the antennas 1240 for transmission, and to demodulate packets received from the antennas 1240. The base station 105-e may include multiple transceivers 1235, each with one or more associated antennas 1240. The transceiver may be an example of a combined receiver 805 and transmitter 815 of FIG. 8.

The memory 1215 may include RAM and ROM. The memory 1215 may also store computer-readable, computer-executable software code 1220 containing instructions that are configured to, when executed, cause the processor 1210 to perform various functions described herein (e.g., memory management for reception of wireless communications, selecting coverage enhancement techniques, call processing, database management, message routing, etc.). Alternatively, the software 1220 may not be directly executable by the processor 1205 but be configured to cause the computer, e.g., when compiled and executed, to perform functions described herein. The processor 1205 may include an intelligent hardware device, e.g., a CPU, a microcontroller, an ASIC, etc. The processor 1205 may include various special purpose processors such as encoders, queue processing modules, base band processors, radio head controllers, digital signal processor (DSPs), and the like.

The base station communications module 1225 may manage communications with other base stations 105. In some cases, a communications management module may include a controller or scheduler for controlling communications with UEs 115 in cooperation with other base stations 105. For example, the base station communications module 1225 may coordinate scheduling for transmissions to UEs 115 for various interference mitigation techniques such as beamforming or joint transmission.

The components of wireless device 400, wireless device 800, wireless device 900, and wireless communications management module 810 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

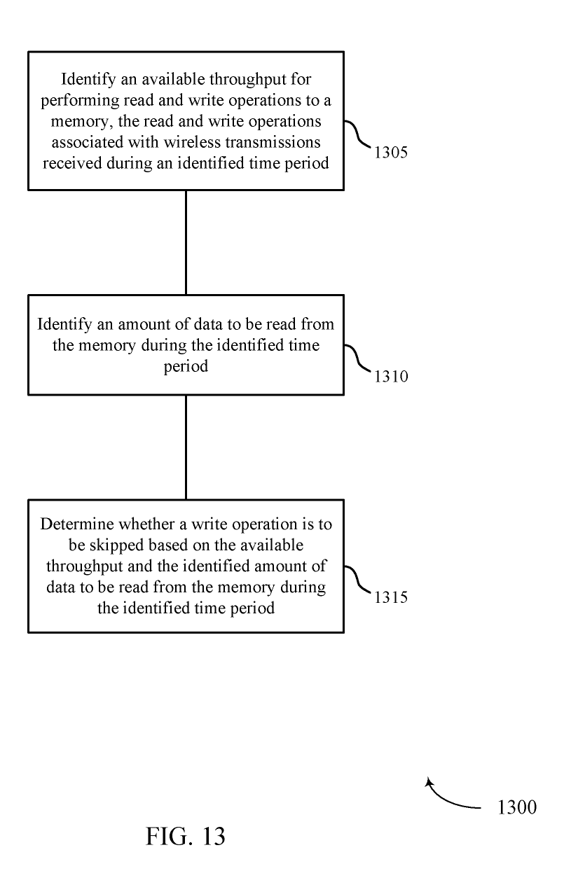

FIG. 13 shows a flowchart illustrating a method 1300 for memory management for reception of wireless communications in accordance with various aspects of the present disclosure. The operations of method 1300 may be implemented by base station 105 or a device 115 or its components as described with reference to FIGS. 1-12. For example, the operations of method 1300 may be performed by the wireless communications management module 410 or 810 as described with reference to FIG. 4 or 8-11. In some examples, a base station 105 or device 115 may execute a set of codes to control the functional elements of the base station 105 or device 115 to perform the functions described below. Additionally or alternatively, the base station 105 or device 115 may perform aspects the functions described below using special-purpose hardware.

At block 1305, the base station 105 or device 115 may identify an available throughput for performing read and write operations to a memory, the read and write operations associated with wireless transmissions received during an identified time period as described with reference to FIGS. 2-7. In certain examples, the operations of block 1305 may be performed by the memory throughput management module 905 as described with reference to FIG. 9.

At block 1310, the base station 105 or device 115 may identify an amount of data to be read from the memory during the identified time period as described with reference to FIGS. 2-7. In certain examples, the operations of block 1310 may be performed by the read profile identification module 910 as described with reference to FIG. 9.

At block 1315, the base station 105 or device 115 may determine whether a write operation is to be skipped based at least in part on the available throughput and the identified amount of data to be read from the memory during the identified time period as described with reference to FIGS. 2-7. In certain examples, the operations of block 1315 may be performed by the memory read/write management module 915 as described with reference to FIG. 9.

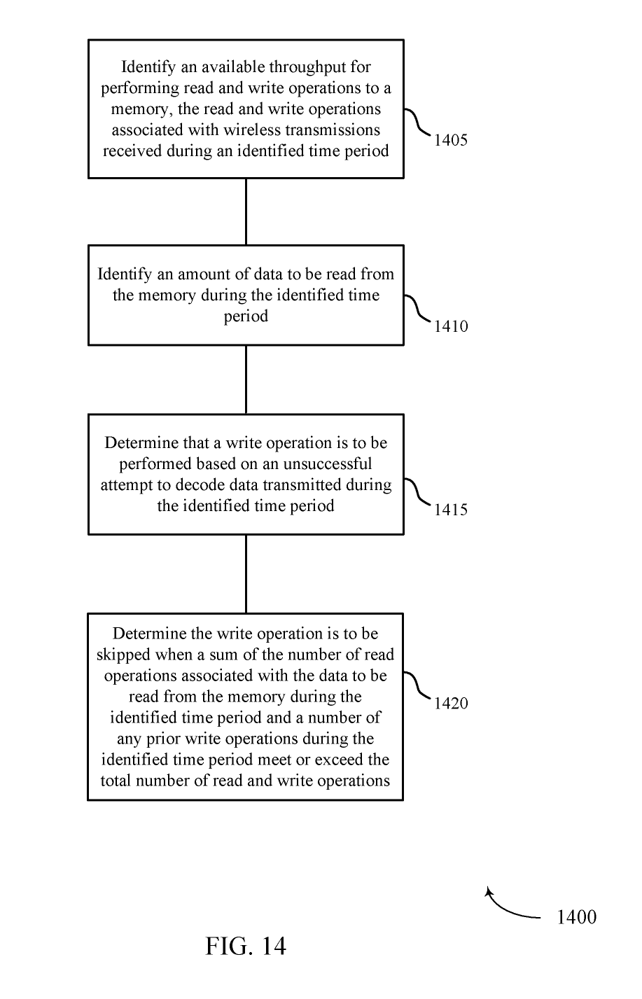

FIG. 14 shows a flowchart illustrating a method 1400 for memory management for reception of wireless communications in accordance with various aspects of the present disclosure. The operations of method 1400 may be implemented by a base station 105 or device 115 or its components as described with reference to FIGS. 1-12. For example, the operations of method 1400 may be performed by the wireless communications management module 810 as described with reference to FIGS. 8-11. In some examples, a base station 105 or device 115 may execute a set of codes to control the functional elements of the base station 105 or device 115 to perform the functions described below. Additionally or alternatively, the base station 105 or device 115 may perform aspects the functions described below using special-purpose hardware. The method 1400 may also incorporate aspects of method 1300 of FIG. 13.

At block 1405, the base station 105 or device 115 may identify an available throughput for performing read and write operations to a memory, the read and write operations associated with wireless transmissions received during an identified time period as described with reference to FIGS. 2-7. In certain examples, the operations of block 1405 may be performed by the memory throughput management module 905 as described with reference to FIG. 9.

At block 1410, the base station 105 or device 115 may identify an amount of data to be read from the memory during the identified time period as described with reference to FIGS. 2-7. In certain examples, the operations of block 1410 may be performed by the read profile identification module 910 as described with reference to FIG. 9.

At block 1415, the base station 105 or device 115 may determine that a write operation is to be performed based on an unsuccessful attempt to decode data transmitted during the identified time period, as described with reference to FIGS. 2-7. In certain examples, the operations of block 1415 may be performed by the memory read/write management module 915 as described with reference to FIG. 9.

At block 1420, the base station 105 or device 115 may determine the write operation is to be skipped when a sum of the number of read operations associated with the data to be read from the memory during the identified time period and a number of any prior write operations during the identified time period meet or exceed the total number of read and write operations, as described with reference to FIGS. 2-7. In certain examples, the operations of block 1420 may be performed by the memory throughput management module 905 as described with reference to FIG. 9.

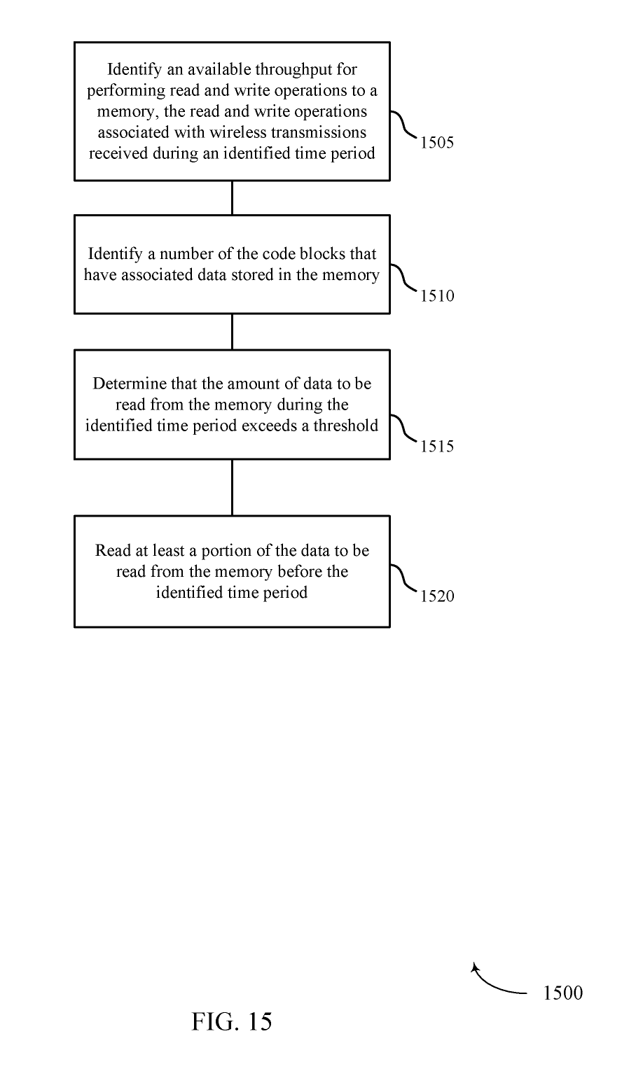

FIG. 15 shows a flowchart illustrating a method 1500 for memory management for reception of wireless communications in accordance with various aspects of the present disclosure. The operations of method 1500 may be implemented by a base station 105 or device 115 or its components as described with reference to FIGS. 1-12. For example, the operations of method 1500 may be performed by the wireless communications management module 410 or 810 as described with reference to FIG. 4 or 8-11. In some examples, a base station 105 or device 115 may execute a set of codes to control the functional elements of the base station 105 or device 115 to perform the functions described below. Additionally or alternatively, the base station 105 or device 115 may perform aspects the functions described below using special-purpose hardware. The method 1500 may also incorporate aspects of methods 1300, and 1400 of FIGS. 13-14.

At block 1505, the base station 105 or device 115 may identify an available throughput for performing read and write operations to a memory, the read and write operations associated with wireless transmissions received during an identified time period as described with reference to FIGS. 2-7. In certain examples, the operations of block 1505 may be performed by the memory throughput management module 905 as described with reference to FIG. 9.

At block 1510, the base station 105 or device 115 may identify a number of the code blocks that have associated data stored in the memory, as described with reference to FIGS. 2-7. In certain examples, the operations of block 1510 may be performed by the read profile identification module 910 as described with reference to FIG. 9.

At block 1515, the device 115 may determine that the amount of data to be read from the memory during the identified time period exceeds a threshold, as described with reference to FIGS. 2-7. In some cases, the threshold may be established as based at least in part on a bandwidth associated with a DDR memory driver interface (e.g., a hardware design parameter). In certain examples, the operations of block 1515 may be performed by the memory read/write management module 915 as described with reference to FIG. 9.

At block 1520, the device 115 may read at least a portion of the data to be read from the memory before the identified time period, as described with reference to FIGS. 2-7. In certain examples, the operations of block 1520 may be performed by the memory read/write management module 915 as described with reference to FIG. 9.

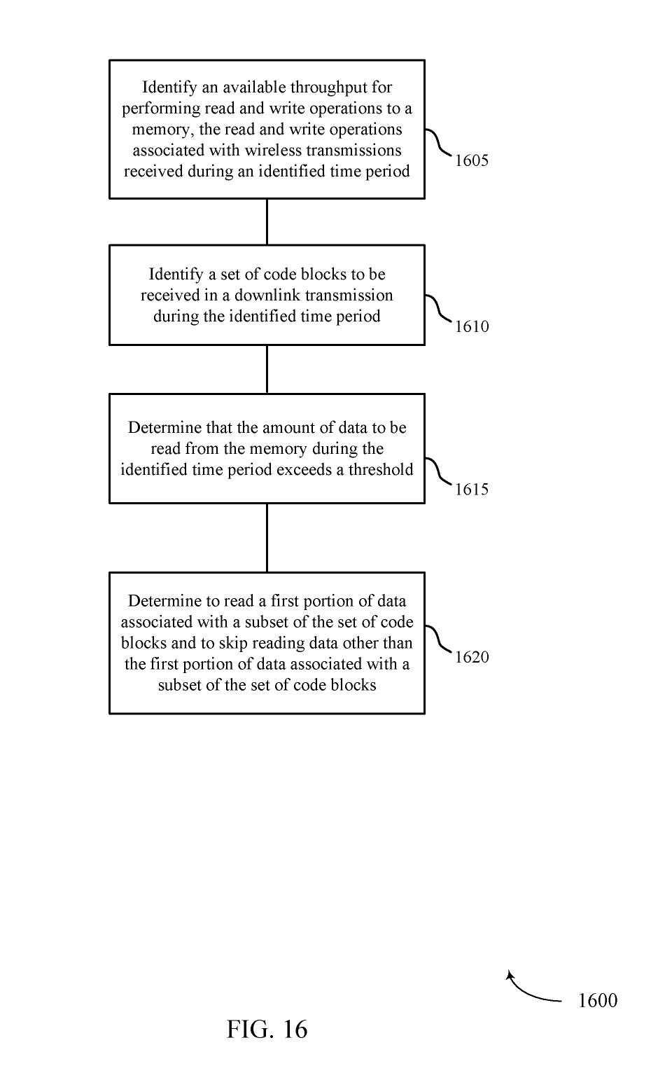

FIG. 16 shows a flowchart illustrating a method 1600 for memory management for reception of wireless communications in accordance with various aspects of the present disclosure. The operations of method 1600 may be implemented by a device 115 or its components as described with reference to FIGS. 1-12. For example, the operations of method 1600 may be performed by the wireless communications management module 810 as described with reference to FIGS. 8-11. In some examples, a device 115 may execute a set of codes to control the functional elements of the device 115 to perform the functions described below. Additionally or alternatively, the device 115 may perform aspects the functions described below using special-purpose hardware. The method 1600 may also incorporate aspects of methods 1300, 1400, and 1500 of FIGS. 13-15.

At block 1605, the device 115 may identify an available throughput for performing read and write operations to a memory, the read and write operations associated with wireless transmissions received during an identified time period as described with reference to FIGS. 2-7. In certain examples, the operations of block 1605 may be performed by the memory throughput management module 905 as described with reference to FIG. 9.

At block 1610, the device 115 may identify a set of code blocks to be received in a downlink transmission during the identified time period, as described with reference to FIGS. 2-7. In certain examples, the operations of block 1610 may be performed by the read profile identification module 910 as described with reference to FIG. 9.

At block 1615, the device 115 may determine that the amount of data to be read from the memory during the identified time period exceeds a threshold as described with reference to FIGS. 2-7. In certain examples, the operations of block 1615 may be performed by the read profile identification module 910 as described with reference to FIG. 9.

At block 1620, the device 115 may determine to read a first portion of data associated with a subset of the plurality of code blocks and to skip reading data other than the first portion of data associated with a subset of the plurality of code blocks as described with reference to FIGS. 2-7. In certain examples, the operations of block 1620 may be performed by the memory read/write management module 915 as described with reference to FIG. 9.

Thus, methods 1300, 1400, 1500, and 1600 may provide for memory management for reception of wireless communications. It should be noted that methods 1300, 1400, 1500, and 1600 describe possible implementation, and that the operations and the steps may be rearranged or otherwise modified such that other implementations are possible. In some examples, aspects from two or more of the methods 1300, 1400, 1500, and 1600 may be combined.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (WiFi), IEEE 802.16 (WiMAX), IEEE 802.20, Flash-OFDM™, etc. UTRA and E-UTRA are part of Universal Mobile Telecommunication System (UMTS). 3GPP LTE and LTE-A are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over one or both of an unlicensed and shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
identifying an available throughput for performing read and write operations to a memory, the read and write operations associated with wireless transmissions received during an identified time period;
identifying an amount of data to be read from the memory during the identified time period; and
determining whether a write operation is to be skipped based at least in part on the available throughput and the identified amount of data to be read from the memory during the identified time period.

2. The method of claim 1, wherein the identified time period corresponds to an orthogonal frequency division multiplexing (OFDM) symbol duration.

3. The method of claim 1, wherein the available throughput for performing read and write operations is based at least in part on a total number of read and write operations that may be performed during the identified time period.

4. The method of claim 3, wherein the determining whether a write operation is to be skipped is further based at least in part on a difference between the total number of read and write operations that may be performed during the identified time period and a number of read operations associated with the data to be read from the memory during the identified time period.

5. The method of claim 4, further comprising:
determining that a write operation is to be performed based at least in part on an unsuccessful attempt to decode data transmitted during the identified time period.

6. The method of claim 5, wherein the write operation is determined to be skipped when a sum of the number of read operations associated with the data to be read from the memory during the identified time period and a number of any prior write operations during the identified time period meet or exceed the total number of read and write operations.

7. The method of claim 1, wherein the identifying the amount of data to be read from the memory during the identified time period comprises:
identifying a plurality of code blocks to be received during the identified time period; and
identifying a number of the plurality of code blocks that have associated data stored in the memory.

8. The method of claim 7, wherein the plurality of code blocks are to be received from two or more pieces of user equipment.

9. The method of claim 7, wherein the identifying the number of the plurality of code blocks that have associated data stored in the memory is based at least in part on a redundancy version identification (RVID) associated with one or more code blocks of the plurality of code blocks.

10. The method of claim 7, further comprising:
determining that the amount of data to be read from the memory during the identified time period exceeds a threshold; and
determining to read a first portion of data associated with a subset of the plurality of code blocks and to skip reading data other than the first portion of data associated with the subset of the plurality of code blocks.

11. The method of claim 10, wherein the first portion of data associated with the subset of the plurality of code blocks comprises systematic data.

12. The method of claim 7, further comprising:
determining that the amount of data to be read from the memory during the identified time period exceeds a threshold;
determining to skip reading data stored in the memory for a subset of the plurality of code blocks;
adjusting a redundancy version in an uplink grant to a user equipment (UE) for transmission of the subset of the plurality of code blocks.

13. The method of claim 7, wherein the read and write operations are associated with a plurality of hybrid automatic repeat request (HARQ) processes associated with data to be transmitted during the identified time period, and wherein the method further comprises:
determining that the amount of data to be read from the memory during the identified time period exceeds a threshold;
determining an amount of data to be read from the memory associated with one or more HARQ processes of the plurality of HARQ processes; and
selecting a first HARQ process of the one or more HARQ processes to be deferred to a different time period than the identified time period.

14. The method of claim 13, further comprising:
selecting a second HARQ process to replace the first HARQ process in an uplink grant.

15. The method of claim 14, wherein the second HARQ process is selected based at least in part on an amount of data to be read from the memory associated with the second HARQ process being less than the amount of data to be read from the memory associated with the first HARQ process.

16. The method of claim 7, wherein the plurality of code blocks are to be received in downlink transmissions from a base station.

17. The method of claim 16, wherein an identification of the plurality of code blocks to be received in the downlink transmissions is provided in a downlink grant from the base station.

18. The method of claim 17, further comprising:
determining that the amount of data to be read from the memory during the identified time period exceeds a threshold; and
reading at least a portion of the data to be read from the memory before the identified time period.

19. The method of claim 17, further comprising:
determining that the amount of data to be read from the memory during the identified time period exceeds a threshold; and
determining to skip reading data associated with a subset of the plurality of code blocks.

20. The method of claim 17, further comprising:
determining that the amount of data to be read from the memory during the identified time period exceeds a threshold; and
determining to read a first portion of data associated with a subset of the plurality of code blocks and to skip reading data other than the first portion of data associated with the subset of the plurality of code blocks.

21. The method of claim 20, wherein the first portion of data associated with the subset of the plurality of code blocks comprises systematic data.

22. The method of claim 17, further comprising:
skipping a write operation associated with at least a first code block based at least in part on the available throughput and the amount of data to be read from the memory during the identified time period; and
transmitting an indication to the base station associated with at least the first code block for use by the base station in adjusting a redundancy version identification (RVID) for a retransmission of at least the first code block.

23. An apparatus for wireless communication, comprising:
a processor;
memory in electronic communication with the processor; and
instructions stored in the memory, the instructions being executable by the processor to cause the apparatus to:
identify an available throughput for performing read and write operations to a memory, the read and write operations associated with wireless transmissions received during an identified time period;
identify an amount of data to be read from the memory during the identified time period; and
determine whether a write operation is to be skipped based at least in part on the available throughput and the identified amount of data to be read from the memory during the identified time period.

24. The apparatus of claim 23, wherein the identified time period corresponds to an orthogonal frequency division multiplexing (OFDM) symbol duration.

25. The apparatus of claim 23, wherein the available throughput for performing read and write operations is based at least in part on a total number of read and write operations that may be performed during the identified time period.

26. The apparatus of claim 23, wherein the instructions are executable by the processor to cause the apparatus to:
identify a plurality of code blocks to be received during the identified time period; and
identify a number of the plurality of code blocks that have associated data stored in the memory.

27. The apparatus of claim 26, wherein the instructions are executable by the processor to cause the apparatus to:
determine that the amount of data to be read from the memory during the identified time period exceeds a threshold;
determine to skip reading data stored in the memory for a subset of the plurality of code blocks; and
adjust a redundancy version in an uplink grant to a user equipment (UE) for transmission of the subset of the plurality of code blocks.

28. The apparatus of claim 26, wherein the read and write operations are associated with a plurality of hybrid automatic repeat request (HARM) processes associated with data to be transmitted during the identified time period, and the instructions are executable by the processor to cause the apparatus to:
determine that the amount of data to be read from the memory during the identified time period exceeds a threshold;
determine an amount of data to be read from the memory associated with one or more HARQ processes of the plurality of HARQ processes; and
select a first HARQ process of the one or more HARQ processes to be deferred to a different time period than the identified time period.

29. An apparatus for wireless communication, comprising:
means for identifying an available throughput for performing read and write operations to a memory, the read and write operations associated with wireless transmissions received during an identified time period;
means for identifying an amount of data to be read from the memory during the identified time period; and
means for determining whether a write operation is to be skipped based at least in part on the available throughput and the identified amount of data to be read from the memory during the identified time period.

30. A non-transitory computer-readable medium storing code for wireless communication, the code comprising instructions executable to:
identify an available throughput for performing read and write operations to a memory, the read and write operations associated with wireless transmissions received during an identified time period;
identify an amount of data to be read from the memory during the identified time period; and
determine whether a write operation is to be skipped based at least in part on the available throughput and the identified amount of data to be read from the memory during the identified time period.
